(19) United States
(12) Patent Application Publication
(10) Pub. No.: US 2016/0168489 A1
(43) Pub. Date: Jun. 16, 2016

(54) METHOD AND SYSTEM FOR GTL PRODUCTION IN FPSO

(71) Applicant: DAEWOO SHIP-BUILDING & MARINE ENGINEERING CO., LTD., Seoul (KR)

(72) Inventors: Hyuk KWON, Seoul (KR); Hyun Jin KIM, Gwangju (KR); Won Seok KIM, Goyang-si (KR)

(73) Assignee: Daewoo Shipbuilding & Marine Engineering Co., Ltd., Seoul (KR)

(21) Appl. No.: 14/907,255

(22) PCT Filed: Jul. 24, 2014
(86) PCT No.: PCT/KR2014/006771

§ 371 Date: Jan. 22, 2016

(30) Foreign Application Priority Data
Jul. 25, 2013 (KR) 10-2013-0087867
May 19, 2014 (KR) 10-2014-0059690

(51) Int. Cl. C10G 65/16; C10G 2/00; C10G 45/00; C01B 3/38

(52) U.S. Cl. CPC C10G 65/16; C01B 3/38; C10G 2/34; C10G 2/32; C10G 45/00; C01B 2203/0227; C01B 2203/062; C01B 2203/0238; C01B 2203/1241

(57) ABSTRACT

Disclosed herein are a gas-to-liquid (GTL) producing method and system for floating production, storage, and offloading (FPSO). The gas-to-liquid (GTL) producing method for FPSO according to the present invention, which is to produce GTL in FPSO, may include:
1) a pre-treating step of pre-treating natural gas produced at an offshore gas field;
2) a reforming step of reacting the pre-treated natural gas in a presence of a catalyst to produce syngas containing hydrogen and carbon monoxide;
3) a synthesis step of supplying the syngas to a Fischer-Tropsch reactor and reacting the syngas to produce liquid hydrocarbon; and
4) an upgrading step of separating the liquid hydrocarbon into gas, naphtha, and syncrude and supplying hydrogen to hydrofinish the liquid hydrocarbon.

### TECHNICAL FIELD

The present invention relates to a gas-to-liquid (GTL) producing method and system for floating production, storage, and offloading (FPSO). More particularly, the present invention relates to a GTL producing method and system for FPSO capable of producing GTL through a reforming step of reforming pre-treated natural gas, a synthesis step of producing liquid hydrocarbon from syngas produced in the reforming step, and upgrading step of hydrofinishing the liquid hydrocarbon, and a GTL producing method and system for FPSO capable of removing air separation units (ASU) to additionally secure a deck space and decrease cost consumed for the ASU.

### BACKGROUND ART

Recently, in accordance with exhaustion of petroleum resources, utilization of alternative resources capable of producing transportation oil, fuel oil, or petrochemical products has been demanded. As a representative hydrocarbon material capable of satisfying this demand, there are coal and natural gas of which reserves are sufficient, and there are eco-friendly alternative hydrocarbon sources such as biomass, wastes, or the like, in view of decreasing CO₂ in order to prevent global warming. As a method capable of producing transportation oil such as gasoline or diesel and chemical products such as alcohol, wax, lube based oil, olefin, or the like, from the alternative hydrocarbon source as described above, a coal-to-liquid (CTL) producing method, a gas-to-liquid (GTL) producing method, and a biomass-to-liquid producing method have been well known.

Gas-to-liquid (GTL) means a technology of processing natural gas to produce liquid synthetic petroleum and a product thereof. Due to continuously high oil price and the requirement for eco-friendly energy, an interest in the GTL producing liquid fuel such as diesel, which is transportation oil, or the like, from natural gas has been increased. The reason is that since the GTL is produced through a process of desulfurizing natural gas, the GTL does not almost contain a sulfur ingredient, which is an air pollutant, such that the GTL may be classified as clean fuel.

A Fischer-Tropsch synthesis method, which is a core process of the GTL technology, started by developing a technology of preparing synthetic fuel from syngas using coal gasification in 1923 by Fischer and Tropsch who were German chemists.

The GTL process is composed of three-stages: a reforming reaction of natural gas, an F-T synthesis reaction of the syngas, and a reforming reaction of a product.

First, a reforming reaction step of producing syngas from natural gas is performed through a reforming reaction of methane, which is a main ingredient of natural gas. As a reforming reaction method, a steam methane reforming (SMR) method, a partial oxidation (PDX) method, an auto-thermal reforming (ATR) method, steam carbon reformer (SCR) method, and the like, may be representative (See Table 1)

Syngas produced through the reforming reaction produces a linear paraffin based hydrocarbon through the F-T synthesis reaction, and an F-T reactor has been developed in a sequence of a fixed bed reactor, a circulating fluid bed reactor, a fixed fluid bed reactor, and a slurry reactor. The F-T synthesis reaction is composed of the following four main reactions.

1) FT Synthesis (Chain Growth)

CO+2H₂→—CH₂+H₂O ΔH(227° C.)=−165 kJ/mol

2) Methanation

CO+3H₂→CH₄+H₂O ΔH(227° C.)=−215 kJ/mol

3) Water Gas Shift

CO+H₂O [symbol] CO₂+H₂ ΔH(227° C.)=−40 kJ/mol

4) Boudouard Reaction

2CO [symbol] C+CO₂ ΔH(227° C.)=−134 kJ/mol

A wax product having a high boiling point, which is produced through the F-T synthesis reaction, may be purified as fuel having a low boiling point through an upgrading reaction to thereby be used.

In an example of this technology disclosed in Korean Patent Laid-Open Publication No. 2012-0054632, a combined reforming process for making a syngas mixture from a desulfurized gaseous hydrocarbon feedstock has been disclosed, wherein the feedstock is split into a first and a second feedstock stream, the first feedstock stream is mixed with steam and fed to a gas heated reformer (GHR) and a steam methane reformer (SMR) operated in series, and the second feedstock stream is mixed with reformed gas coming from the SMR and fed with oxygen to a non-catalytic partial oxidation reformer (PDX).

In accordance with environmental regulation with respect to transportation fuel, it is expected that the GTL technology as described above will be a unique technology for preparing clean fuel while having economical efficiency before hydrogen fuel is commercialized. However, in a GTL technology field, innovative companies have already taken steps to occupy a market, and as a result, entry into the technology field regarding GTL technology is difficult, such that development by independent companies is required. Therefore, research into the development of the GTL technology has been conducted in Korea.

### DISCLOSURE

### Technical Problem

Recently, since the development of offshore gas fields has been actively conducted, it is expected that an offshore plant applying a GTL technology to natural gas produced from the offshore gas fields will become a competitive technology.

However, it is difficult to apply an onshore GTL plant technology itself to the offshore plant due to various variables caused by offshore environments.

The offshore plant should be designed in consideration of utilization of a limited space, stability against movement by tidal current, or the like, and a weight of the plant and the center of gravity thereof, and the fact that a raw material to be required or an apparatus component may not be instantly supplied should be considered. Therefore, there is a need to simplify the process and allow the plant to be compact by designing the offshore plant so as to decrease the number of processes as much as possible.

For example, air separation units (ASU) require a significantly large space and a height of a cooling device is significantly high. These apparatuses are not preferable for floating production, storage, and offloading (FPSO). Further, pure oxygen produced in the ASU has a large risk of explosion and fire in a limited space.

Therefore, in a FPSO concept according to the related art, a necessity for the ASU may be avoided by preparing syngas using air instead of using pure oxygen. In this case, a size of a device may be substantially increased, such that an installation area may be increased, and installation cost may be increased. Further, there is a need for an F-T reactor in which there is no re-circulation of un-reacted gas, and there is a single path.

Meanwhile, FIG. 1 schematically illustrates a flow of an F-T synthesis reaction of reformed syngas and an upgrading process in a GTL producing method according to the related art.

As illustrated in FIG. 1, reformed syngas is supplied to the F-T synthesis reactor FT, such that FT liquid is synthesized. A product of the F-T reactor is upgraded through a separator, hydrocracking (HCK), and hydrotreating (HDT).

During the processes, unconverted H₂ and CO are separated in the separator to thereby be re-supplied to the F-T reactor FT. The hydrocracking (HCK) is a process of converting heavy n-paraffin of wax into light n-paraffin or iso-paraffin, and the hydrotreating (HDT) is a process of hydrogenating and isomerizing linear paraffin and olefin.

In the upgrading process as described above, a large number of apparatuses are required due to a complicated process, and various kinds of GTL products are produced after the process, such that there is a need to prepare a plurality of tanks for storing the produced GTL products. As a large number of apparatuses are required for the upgrading process, and the number of tanks to be required is increased, disposition of equipment is inefficient for being applied to an offshore plant.

Further, since a large amount of hydrogen is required for upgrading, hydrogen plant is required as an essential component, and in a case of the onshore plant, cost in the upgrading process occupies a large part (up to 10%) of an overall plant installation cost.

An aspect of the present invention is to provide a gas-to-liquid (GTL) producing method and system suitable for the offshore plant, capable of solving the problems as described above.

### Technical Solution

According to an aspect of the present invention, there is provided a gas-to-liquid (GTL) producing method for floating production, storage, and offloading (FPSO) including:

1) a pre-treating step of pre-treating natural gas produced at an offshore gas field;

2) a reforming step of reacting the pre-treated natural gas in a presence of a catalyst to produce syngas containing hydrogen and carbon monoxide;

3) a synthesis step of supplying the syngas to a Fischer-Tropsch reactor and reacting the syngas to produce liquid hydrocarbon; and

4) an upgrading step of separating the liquid hydrocarbon into gas, naphtha, and syncrude and supplying hydrogen to hydrofinish the liquid hydrocarbon.

Preferably, the upgrading step may include:

1) a separation step of separating the liquid hydrocarbon produced in the synthesis step into gas having 1 to 4 carbon atoms, naphtha, and syncrude; and

2) a hydrofinishing step of supplying hydrogen to the separated naphtha to saturate olefin.

Preferably, a condensate produced in the hydrofinishing step may be separated to thereby be mixed with the syncrude separated in the separation step, and

Gum formation and polymerization of olefin contained in at least one of the naphtha and syncrude during storage and transportation may be prevented through the hydrofinishing step.

Preferably, the gas having 1 to 4 carbon atoms separated in the separation step may be supplied as fuel for the FPSO.

Preferably, the hydrofinishing step may be performed at a relatively low temperature of 250 to 290° C. and a relatively low pressure of 15 to 30 bars.

Preferably, the GTL producing method for FPSO may further include a conditioning step of conditioning the syngas produced after the reforming in the reforming step before supplying the syngas to the Fischer-Tropsch reactor of the synthesis step, wherein hydrogen generated during the conditioning may be at least partially supplied to the upgrading step.

Preferably, the reforming step may be performed in a steam CO₂ reformer (SCR) supplying steam and carbon dioxide to the natural gas and reacting the natural gas in a presence of the catalyst, and the Fischer-Tropsch reactor in the synthesis step may be a slurry phase reactor (SPR).

Preferably, the steam CO₂ reformer may be a compact reformer.

Preferably, carbon dioxide may participate in a production reaction of the syngas as a reverse reaction of a water gas shift reaction in the compact reformer.

Preferably, the syngas unreacted in the slurry phase reactor may be recovered to thereby be re-supplied to the synthesis step.

Preferably, steam generated in the synthesis step and the reforming step may be supplied to a steam turbine power generator provided in the FPSO, thereby generating power.

Preferably, in the conditioning step, H₂O may be separated in multiple steps from the syngas produced after the reforming, and hydrogen is separated so as to satisfy requirement conditions in the Fischer-Tropsch reactor, but H₂ may be recovered so that a ratio(SN) of H₂/CO supplied to the Fischer-Tropsch reactor satisfies 1 to 2.5.

Preferably, hydrogen recovered in the conditioning step may be at least partially supplied as fuel in the reforming step.

Preferably, the reforming step may be performed in a steam methane reformer (SMR) reacting the natural gas with hydrogen supplied in the conditioning step.

According to another aspect of the present disclosure, there is provided a GTL producing system for FPSO including:

a pre-treating unit in which pre-treatment including desulfurization is performed on natural gas produced at an offshore gas field;

a reformer receiving natural gas from the pre-treating unit to produce syngas containing hydrogen and carbon monoxide;

a Fischer-Tropsch reactor receiving the syngas from the reformer to produce liquid hydrocarbon; and

an upgrading unit receiving hydrogen and the liquid hydrocarbon from the Fischer-Tropsch reactor and hydrofinishing the liquid hydrocarbon to produce naphtha and syncrude.

Preferably, the GTL producing system for FPSO may further include a conditioning unit conditioning the syngas produced in the reformer before the syngas is supplied to the Fischer-Tropsch reactor, wherein hydrogen produced in the conditioning unit may be supplied to the upgrading unit.

Preferably, the reformer may be a steam CO₂ reformer (SCR) receiving the natural gas to supply steam and carbon dioxide, and reacting the natural gas in the presence of a catalyst to produce the syngas containing hydrogen and carbon monoxide, and the Fischer-Tropsch reactor may be a slurry phase reactor (SPR).

Preferably, the upgrading unit may supply hydrogen to the liquid hydrocarbon and hydrofinish the liquid hydrocarbon to saturate olefin contained in at least one of the naphtha and syncrude, thereby making it possible to prevent gum formation and polymerization of the olefin during storing and transporting at least one of the naphtha and syncrude.

Preferably, compounds having 1 to 4 carbon atoms, produced in the Fischer-Tropsch reactor and the upgrading unit may be supplied as fuel of a complex power generation system of the FPSO.

Preferably, the conditioning unit may include first to third separators separating H₂O from the syngas in multiple steps and an extractor recovering hydrogen from hydrogen and carbon monoxide separated in the third separator.

Preferably, the reformer may be a steam methane reformer (SMR) reforming the pre-treated natural gas and H₂O and CO₂ into combustion gas and hydrogen, and CO and H₂O using hydrogen recovered in the extractor.

Preferably, the extractor may be provided with a membrane capable of adjusting an amount of passed hydrogen.

Preferably, hydrogen recovered by the membrane may be supplied to the reformer and the upgrading unit.

A ratio(SN) of H₂/CO supplied from the conditioning unit to the Fischer-Tropsch reactor may be 1 to 2.5.

### Advantageous Effects

In a GTL producing method and system for FPSO, GTL may be produced through a pre-treating step of pre-treating natural gas produced at an offshore gas field, a reforming step of reforming the pre-treated natural gas, a synthesis step of producing liquid hydrocarbon from syngas produced in the reforming step, and an upgrading step of hydrofinishing the liquid hydrocarbon.

According to the present invention, a GTL producing method and system capable of being effectively utilized and disposed in a limited topside of FPSO may be provided by optimizing the GTL producing method for an offshore plant environment and specifically simplifying an upgrading process.

Tandem offloading of GTL produced in the GTL producing method and system according to the present invention may be performed by sharing the same offloading apparatus, such that the GTL producing method and system may be suitable for implementing a compact offshore plant mounted in the FPSO.

Further, according to the present invention, safety in the FPSO may be secured by removing a necessity of pure oxygen, and a deck space on the FPSO and installation cost may be saved by removing an oxygen supply device.

In addition, according to the present invention, syngas having a high ratio of H₂:CO, produced through a SMR reactor may be produced so as to have a ratio of H₂:CO suitable for an F-T reactor, and H₂ separated from the syngas may be used as fuel for treating FT products and increasing a temperature of a reformer, thereby making it possible to decrease an operating cost in a GTL-FPSO.

### DESCRIPTION OF DRAWINGS

FIG. 1 schematically illustrates a process flow of an F-T synthesis reaction of reformed syngas and an upgrading process in a GTL producing method according to the related art.

FIG. 2 schematically illustrates a process flow of a GTL producing method according to a first embodiment of the present invention, and FIG. 3 illustrates a detailed process flow.

FIG. 4 separately illustrates a process flow of an upgrading step according to the first embodiment of the present invention.

FIG. 5 schematically illustrates a FPSO of which a plant using the GTL producing method according to the first embodiment of the present invention is provided in a topside.

FIG. 6 is a block diagram of a FT GTL device on the FPSO using a SMR according to a second embodiment of the present invention.

FIG. 7 is a configuration diagram for describing a coupling relationship between main units illustrated in FIG. 6.

FIG. 8 is a process diagram for describing a FT GTL method on the FPSO using the SMR according to the second embodiment of the present invention.

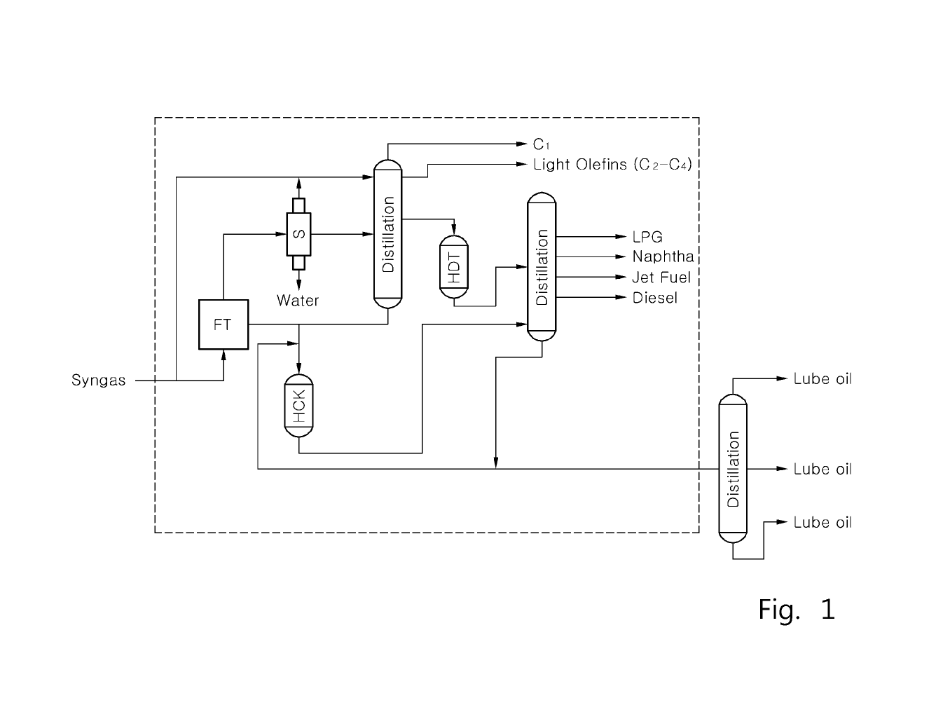

### EMBODIMENTS

In order to sufficiently understand the present invention, operational advantages of the present invention, and objects achieved by the present invention, there is a need to refer to the accompanying drawings illustrating preferable embodiments of the present invention and contents illustrated in the accompanying drawing.

Hereinafter, the present invention will be described in detail by describing embodiments of the present invention with reference to the accompanying drawings. Like reference numerals proposed in each drawing denote like components.

Monetization using natural gas may be largely classified into four types. Examples of monetization using the natural gas may include 1) LNG production through liquefaction of the natural gas, which is the most general, and 2) DME production, 3) methanol production, and 4) GTL production through reformation, synthesis, separation, and purification of the natural gas. Among them, the present invention relates to a GTL producing method capable of producing GTL which may be used as clean fuel for transportation instead of petroleum diesel.

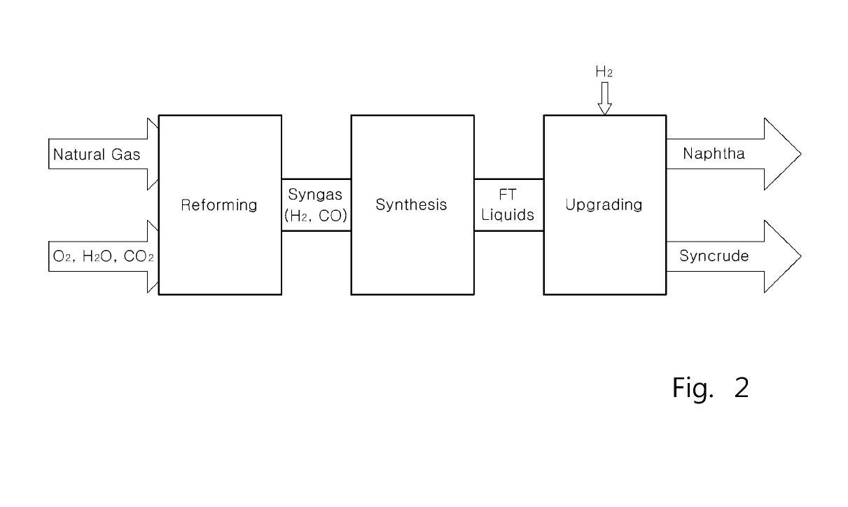

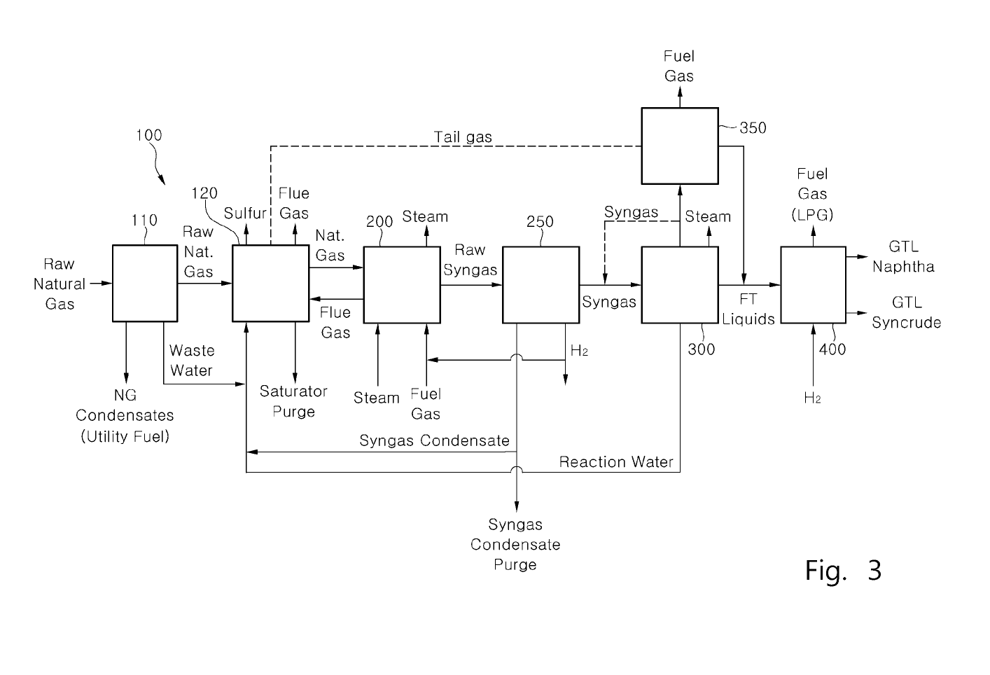

FIG. 2 schematically illustrates a process flow of a GTL producing method according to a first embodiment of the present invention. In the GTL producing method according to the present invention, GTL containing naphtha and syncrude may be produced through a reforming step of supplying oxygen, water, and carbon dioxide to the natural gas to reform the natural gas, a synthesis step of putting the syngas produced in the reforming step into a reactor to synthesize liquid hydrocarbon, and an upgrading step of upgrading the liquid hydrocarbon. FIG. 3 illustrates a detailed process view according to the present embodiment.

As illustrated in FIGS. 2 and 3, the GTL producing method according to the first embodiment of the present invention, which is a method for producing GTL in floating production, storage, and offloading (FPSO), includes: 1) a pre-treating step (100) of pre-treating natural gas produced at an offshore gas field, 2) a reforming step (200) of supplying steam and carbon dioxide to the pre-treated natural gas and reacting the pre-treated natural gas in a presence of a catalyst to produce syngas containing hydrogen and carbon monoxide, 3) a synthesis step (300) of supplying the syngas to a Fischer-Tropsch reactor and reacting the syngas to produce liquid hydrocarbon; and 4) an upgrading step (400) of separating the produced liquid hydrocarbon into gas, naphtha, and syncrude and supplying hydrogen to hydrofinish the liquid hydrocarbon.

The pre-treating step may include a gas inlet stabilization step (110) of stabilizing the natural gas produced at the offshore gas field, a sulfur removal saturator treating step (120), a pre-reforming step, and the like. The natural gas of which a main component is composed of methane by pre-treatment is supplied to the reforming step (200).

In the present embodiment, the reforming step (200) may be performed in a steam CO₂ reformer (SCR), and the Fischer-Tropsch reactor of the synthesis step (300) may be a slurry phase reactor (SPR).

As the steam CO₂ reformer according to the present embodiment, for example, a DPT compact reformer may be applied. In a general steam CO₂ reformer, important reaction formulas are CH₄+H₂O→3H₂+CO, and CH₄+CO₂→2CO+H₂, and syngas containing hydrogen and carbon monoxide is produced through the reformer.

In a syngas synthesis reaction (CH₄+CO₂→2CO+H₂) as described above in which carbon dioxide participates in the general steam CO₂ reformer, an activity of a catalyst is decreased due to a coking reaction, which is a side reaction in a reforming reaction of carbon dioxide, such that a conversion rate may be decreased.

Here, in a case of using a compact reformer, carbon dioxide among feed gases participates in a synthesis reaction of the syngas by a reverse reaction of a water gas shift reaction (H₂+CO₂→CO+H₂O). Therefore, in the case of using the compact reformer, it is possible to satisfy R Ratio=(H₂—CO₂)/(CO+CO₂)≈2.1, such that the coking reaction may be prevented, thereby making it possible to increase a lifetime of the catalyst and the conversion rate.

Meanwhile, the steam CO₂ reformer as described above may be used in a numerous stranded gas fields containing a large amount of CO₂ due to high CO₂ tolerance, and may also be utilized and operated in a high CO₂ natural gas in which a content of carbon dioxide is up to 30%. Particularly, in the steam CO₂ reformer such as the compact reformer, which does not require air separation units (ASU), safety concerns may be decreased, and a space to be required, a weight, a height, and an electricity consumption amount of the steam CO₂ reformer, and the like, may be small as compared to an autothermal reactor (ATR) or partial oxidation reactor (PDX). Further, a ratio of H₂/CO of about 2.0, which is a target ratio required for a GTL process, may be satisfied.

In addition, since ship motion effects are relatively small in the compact reformer as compared to other reformers, and since a size thereof is small due to a structure of the reactor in a form of a heat exchanger, a space required for installation is relatively small, such that the compact reformer is particularly suitable for the offshore plant.

The syngas produced after being reformed through the reforming step (200) in the steam CO₂ reformer may be conditioned through a conditioning step (250), and then supplied to the Fischer-Tropsch reactor of the synthesis step (300). The conditioning step is a process of adjusting compositions of the syngas, and hydrogen generated during the conditioning of the syngas may be at least partially supplied for hydrofinishing of the above-mentioned upgrading step (400).

According to the present embodiment, as the Fischer-Tropsch reactor, the slurry phase reactor (SPR) may be used. For example, a Sasol slurry phase reactor (SPR) may be used. In a case of the slurry phase reactor (SPR), ship motion effects are small, and an overall space to be required is relatively small and a weight thereof is relatively light, such that the slurry phase reactor (SPR) may be suitable for being used in the offshore plant. Further, since the SPR has a structure in which a catalyst floats and circulates, it may be easy to replace the catalyst as compared to other reactors such as a multi-tubular fixed bed (MTFB) reactor, such that the SPR may be effectively utilized in the offshore plant in which replacement or supply of an apparatus, or the like, cannot be smoothly performed.

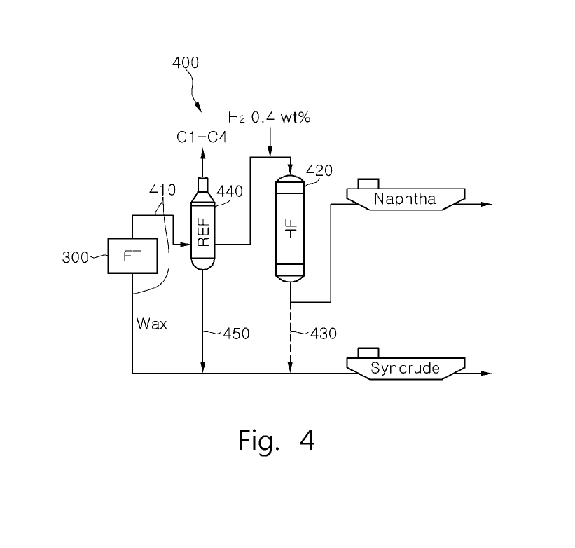

FIG. 4 separately illustrates only a process flow of the upgrading step (400).

As illustrated in FIG. 4, the upgrading step (400) according to the present embodiment includes 1) a separation step (410) of separating the liquid hydrocarbon produced in the synthesis step (300) into gas having 1 to 4 carbon atoms, naphtha, and syncrude; and 2) a hydrofinishing step (420) of supplying hydrogen to the separated naphtha to saturate olefin, wherein a condensate produced in the hydrofinishing step (420) is separated to thereby be mixed with the syncrude separated in the separation step described above (430).

The syncrude (wax in FIG. 4) produced in the Fischer-Tropsch reactor and separated in the separation step (410) and condensate produced in the hydrofinishing step (420) are mixed with each other to thereby be shipped and transported (430) together with each other as the syncrude.

The hydrofinishing step (420) according to the present embodiment is performed at a relatively low temperature of 250 to 290° C. and a relatively low pressure of 15 to 30 bars, and gum formation and polymerization of olefin contained in at least one of the naphtha and syncrude during storage and transportation may be prevented through the hydrofinishing step.

An upgrading process (400) of the liquid hydrocarbon produced through the Fischer-Tropsch reactor may be variously designed depending on the kind of final product to be produced. In the case in which there is need to perform a full upgrading process including a hydrocracking process and hydrotreating process as in an onshore plant, various products may be produced, such that the full upgrading process may be suitable for the onshore plant. However in a case of applying the full upgrading process to the offshore plant, a design of the process may become complicated, and since there is a need to prepare tanks depending on the kinds of product and to store each of the products in the corresponding tank, the number of tanks is increased, such that an installation space and cost may be increased, and it is difficult to efficiently dispose the tanks. Since there is a need to offload the products through different offloading equipment depending on the kind of products at the time of offloading the products, piping layout may become complicated.

According to the present embodiment, the liquid hydrocarbon is upgraded through a simplified upgrading process of hydrogenating olefin contained in the naphtha or syncrude through the hydrofinishing step (420) to prevent gum formation and polymerization during storing and transporting olefin.

According to the present invention, the process is designed so as to produce a GTL product from only the naphtha and syncrude as described above, and the liquid hydrocarbon is upgraded only by the hydrofinishing which may be operated under relatively low pressure and temperature conditions. Therefore, a process of the upgrading step (400) may become simplified, an amount of hydrogen required for the process may be decreased, and the number of apparatuses may be decreased, such that the GTL producing method according to the present embodiment may be suitable for being applied to a limited space of the FPSO.

The syngas unreacted in the slurry phase reactor of the synthesis step (300) described above may be recovered to thereby be re-supplied to a front end of the slurry phase reactor of the synthesis step (see the synthesis step (300) in FIG. 4).

According to the present embodiment, the gas having 1 to carbon atoms, separated in the separation step (410) may be supplied as fuel of the FPSO, and steam generated in the synthesis step (300) and the reforming step (200) may be supplied to the steam turbine power generator provided in the FPSO, thereby generating power.

Since the gas separated in the separation step (410) is mostly composed of light olefins, and an amount of gas is relatively small to be stored and then transported, it is preferable to consume the gas as the fuel in the FPSO, and electricity required in the FPSO may be produced and energy efficiency may also be increased by supplying the steam from the synthesis step (300) and the reforming step (200) to the steam turbine power generator to generate power.

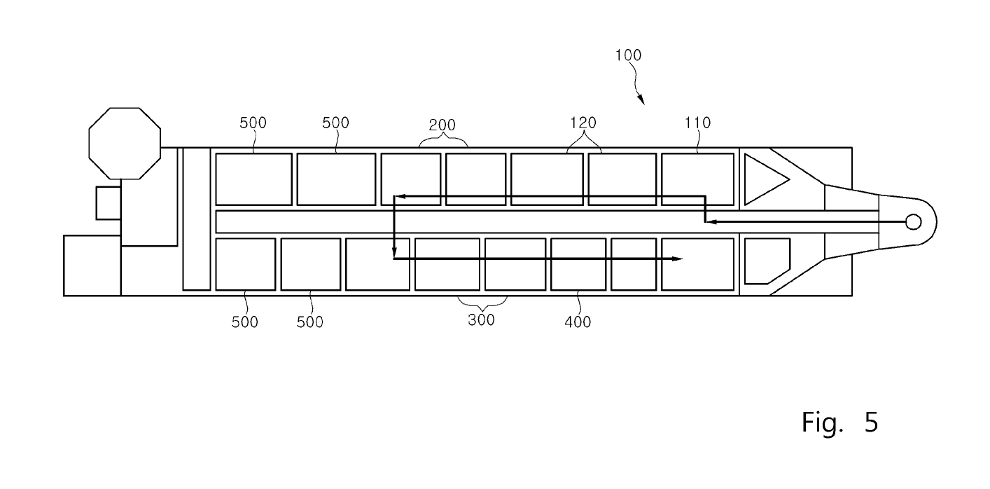

FIG. 5 schematically illustrates a form in which equipment 100, 200, 300, 400 and 500 for respective process steps which are provided in the topside of the FPSO to which the GTL producing method according to the present embodiment is applied, and a flow of the process steps.

In order to implement the first embodiment as described above, a GTL producing system for FPSO includes a pre-treating unit in which pre-treatment including desulfurization is performed on natural gas produced at an offshore gas field; a steam CO₂ reformer (SCR) receiving natural gas from the pre-treating unit to supply steam and carbon dioxide and reacting the natural gas in a presence of a catalyst to produce syngas containing hydrogen and carbon monoxide; a slurry phase reactor (SPR) receiving the syngas from the steam CO₂ reformer to produce liquid hydrocarbon; and an upgrading unit receiving hydrogen and the liquid hydrocarbon from the slurry phase reactor and hydrofinishing the liquid hydrocarbon to produce naphtha and syncrude.

Preferably, the present system may further include a conditioning unit conditioning the syngas produced in the steam CO₂ reformer before the syngas is supplied to the slurry phase reactor, wherein hydrogen produced in the conditioning unit may be supplied to the upgrading unit.

In the present system, the upgrading unit may supply hydrogen to the liquid hydrocarbon and hydrofinish the liquid hydrocarbon to saturate olefin contained in at least one of the naphtha and syncrude, thereby making it possible to prevent gum formation and polymerization of the olefin during storing and transporting at least one of the naphtha and syncrude.

In the present system, preferably, compounds having 1 to carbon atoms, produced in the slurry phase reactor and the upgrading unit may be supplied as fuel of a complex power generation system of the FPSO.

As described above, in the GTL producing method and system for FPSO according to the first embodiment of the present invention, GTL may be produced through the pre-treating step of pre-treating the natural gas produced at the offshore gas field, the reforming step of reforming the pre-treated natural gas in the steam CO₂ reformer, the synthesis step of producing the liquid hydrocarbon in the slurry phase reactor from the syngas produced in the reforming step, and the upgrading step of hydrofinishing the synthesize liquid hydrocarbon. Therefore, the present embodiment provides the GTL producing method and system optimized for the offshore plant environment.

Particularly, according to the first embodiment, apparatuses caused by a complicated upgrading process are not required by simplifying the upgrading process of the synthesized liquid hydrocarbon into the hydrofinishing, such that the GTL producing system may be effectively disposed in the limited topside of the FPSO, and the apparatuses may be simply and easily installed and maintained. Further, there is no need for a large amount of hydrogen as in the complicated upgrading process of an existing onshore plant, such that there is no need for a large hydrogen plant, and installation and operation cost of the upgrading process may be decreased.

Further, since in the GTL producing method and system for FPSO according to the first embodiment, only three kinds of GTLs, that is, naphtha, syncrude, and the condensate formed during the hydrofinishing, are produced, the kind of tanks for storing the GTL may be simplified, and disposition of the tanks and pipes for transportation may be simplified. Tandem offloading of the GTL produced according to the first embodiment may be performed by sharing the same offloading apparatus, such that offloading equipment may be simplified. Therefore, the GTL producing method and system may be suitable for implementing a compact offshore plant mounted in the FPSO.

Next, a concept of a second embodiment of the present invention will be described first.

A concept of using a steam methane reformer (SMR) in the second embodiment of the present invention is that a ratio of H₂:CO of the produced syngas is 3.0 to 4.5 (the ratio is changed depending on a composition of raw materials put into the SMR), which is higher than a numerical value (a ratio of H₂:CO=2.0) required in the Fischer-Tropsch reactor, such that in order to adjust the ratio of H₂:CO to be 2.0, a membrane recovering H₂ is used for removing excessive hydrogen.

Hydrogen separated by the membrane may be used as fuel of a burner for the steam methane reformer (SMR). Further, according to the present invention, the concept includes to determine a FT external circulation and discharge ratio as a SMR operation variable while securing hydrogen required to improve a FT product.

Further, an excess of hydrogen (more than an amount directly required in the FT reactor) may be supplied to treat the FT GTL product, such that a space and cost required to a separate hydrogen producing system may be decreased.

That is, the SMR produces syngas in which a ratio of H₂:CO is higher than the ratio of H₂:CO required in the Fischer-Tropsch reactor (FT reactor). However, according to the present embodiment, a necessity of installing an additional hydrogen producing apparatus may be removed by providing a hydrogen recovering membrane, such that the syngas having a suitable ratio of H₂/CO may be supplied to the FT reactor, and the excess of hydrogen may be used to treat the FT product.

Hereinafter, a configuration according to the second embodiment of the present invention will be described with reference to the accompanying drawings.

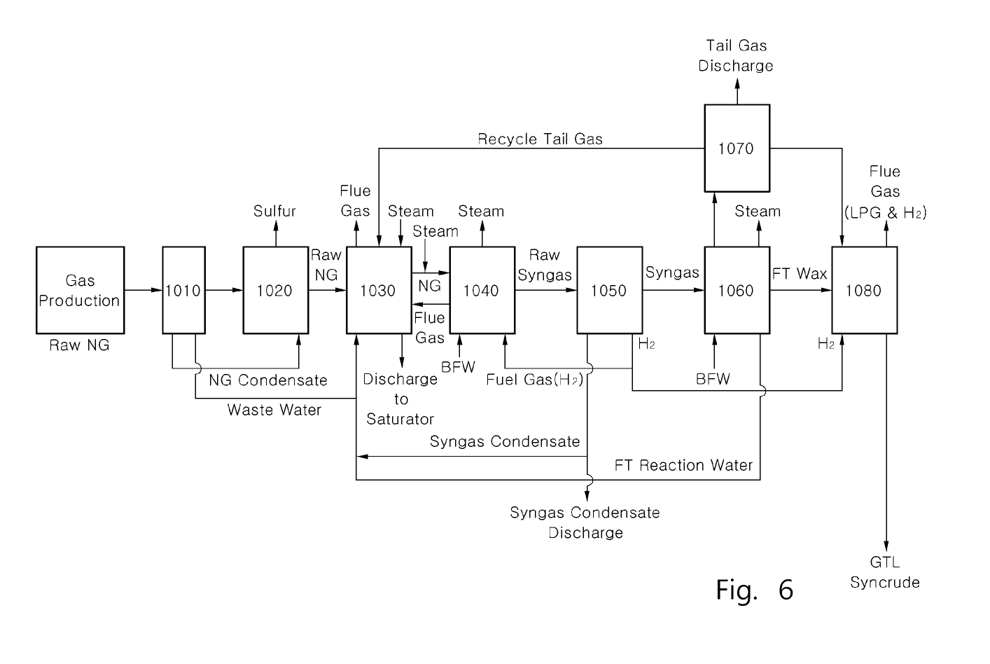

FIG. 6 is a block diagram of a GTL producing system on the FPSO using the SMR according to the second embodiment of the present invention.

The GTL producing system on the FPSO using the SMR according to the second embodiment, which is a FT GTL system for producing single syncrude in the FPSO, includes a gas injection stabilizing unit 1010 receiving produced gas, a desulfurizing unit 1020, a natural gas saturating and pre-reforming unit 1030, a small reforming unit 1040, a conditioning unit 1050, a FT synthesizing unit 1060, a tail gas separating unit 1070, and an upgrading unit 1080 for production treatment as illustrated in FIG. 6. The gas injection stabilizing unit 1010 may perform stabilization on produced raw natural gas (RAW NG) to produce a natural gas (NG) condensate and water (H₂O), and the natural gas condensate is supplied to the desulfurizing unit 1020.

The desulfurizing unit 1020 removes sulfur contained in the natural gas and supply the raw natural gas to the natural gas saturating and pre-reforming unit 1030. The raw natural gas pre-treated in the natural gas saturating and pre-reforming unit 1030 is partially used as fuel gas, and the remaining natural gas is heated by steam to thereby be supplied to the reforming unit 1040 and discharged to a saturator.

In the reforming unit 1040, natural gas passed through steam and supplied from the natural gas saturating and pre-reforming unit 1030 is reformed into raw syngas (RAW SYNGAS). Further, gas that is not treated in the reforming unit 1040 is supplied to the natural gas saturating and pre-reforming unit 1030 as the fuel gas.

The raw syngas treated in the reforming unit 1040 is produced as syngas in the conditioning unit 1050, and hydrogen (H₂) generated in this process is supplied to the reforming unit 1040 and the upgrading unit 1080 as the fuel gas. Further, a syngas condensate produced in the conditioning unit 1050 is supplied to the natural gas saturating and pre-reforming unit 1030 or discharged.

The syngas supplied from the conditioning unit 1050 passes through the FT synthesizing unit 1060 and is separated into a first mixture of naphtha and FT heavy oil and FT wax to thereby be supplied to the upgrading unit 80.

The tail gas separating unit 1070 separates tail gas from the syngas supplied from the FT synthesizing unit 1060, and the tail gas is partially discharged or supplied to the natural gas saturating and pre-reforming unit 1030 to thereby be recycled.

The upgrading unit 1080 mixes the first mixture and the FT wax supplied from the FT synthesizing unit 1060 with each other to discharge or store fuel gas (liquefied petroleum gas (LPG) and H₂) and syncrude products (FT naphtha, FT heavy oil, and FT wax).

Meanwhile, boiler feed water (BFW) for forming steam is supplied to the reforming unit 1040 and the conditioning unit 1050.

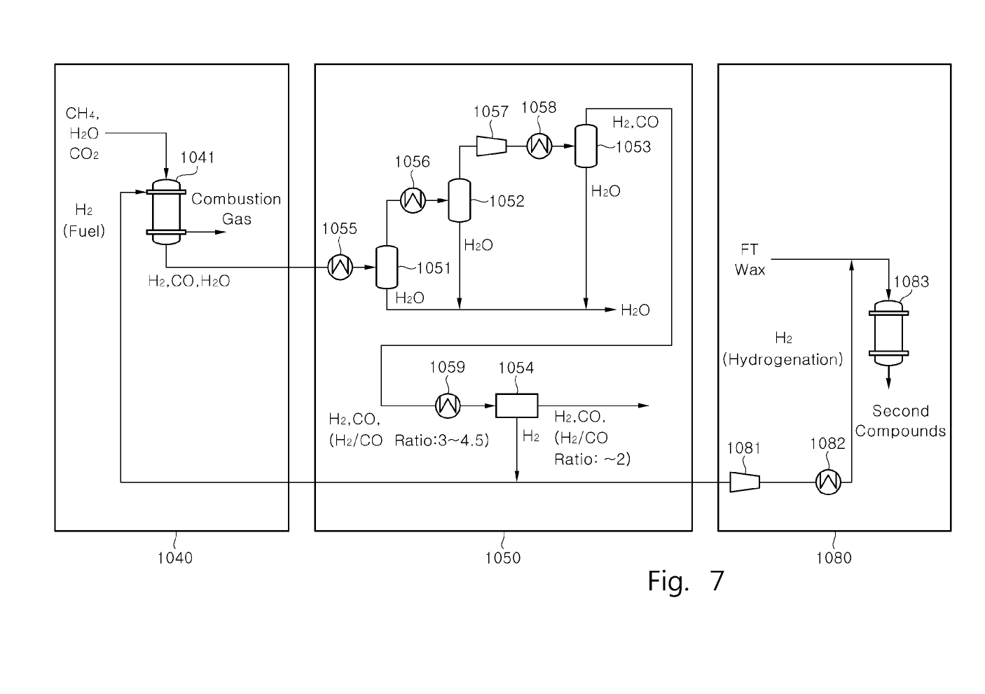

Next, configurations of the reforming unit 1040, the conditioning unit 1050, and the upgrading unit 1080, which are main features of the present embodiment, will be described with reference to FIG. 7.

FIG. 7 is a configuration diagram for describing a coupling relationship between main units illustrated in FIG. 6.

The reforming unit 1040 produces mixed gas of H₂, CO, and H₂O and combustion gas so as to add H₂ produced in the conditioning unit 1050 to the produced natural gas to thereby reform the raw syngas (RAW SYNGAS) as illustrated in FIG. 7. To this end, the reforming unit 1040 includes a small reformer 1041 reforming CH₄, H₂O, and CO₂ contained in the natural gas into combustion gas and H₂, CO, and H₂O by H₂ supplied from the conditioning unit 1050.

The conditioning unit 1050 separates H₂O from the mixed gas of H₂, CO, and H₂O supplied from the reforming unit 1040 in multiple steps and separates H₂ and H₂O so as to satisfy requirements in the FT synthesizing unit 1060. To this end, the conditioning unit 1050 includes first to third separators 1051 to 1053 separating H₂O from the mixed gas in multiple steps and an extractor 54 recovering H₂ from H₂ and CO separated in the third separator 1053, wherein a ratio(SN) of H₂/CO supplied from the extractor 54 to the FT synthesizing unit is maintained at 1 to 2.5.

Preferably, the ratio(SN) of H₂/CO is maintained at 2.0.

That is, in the conditioning unit 50, as illustrated in FIG. 7, H₂O is primarily separated in the first separator 1051 from the mixed gas of H₂, CO, and H₂O supplied from the reforming unit 1040 and passed through the first heat exchanger 1055, H₂O is secondarily separated in the second separator 1052 from mixed gas that is not separated in the first separator 1051 and passed through a second heat exchanger 1056, and H₂O is tertiarily separated in the third separator 1053 from mixed gas that is not separated in the second separator 1052 and passed through a compressor 1057 and a third heat exchanger 1053, such that the resultant is discharged as the syngas condensate.

H₂ and CO that are not separated as H₂O in the third separator 1053 pass through a fourth heat exchanger 1059 to thereby be supplied to the extractor 1054, and the extractor 1054 is provided with the membrane capable of adjusting an amount of passed H₂. That is, the ratio(SN) of H₂/CO supplied to the FT synthesizing unit 1060 is maintained at 1 to 2.5 by the membrane recovering the H₂. Meanwhile, H₂ recovered by the membrane is supplied to the reformer 1041 as fuel, and supplied to the upgrading unit 1080 in order to treat the FT wax supplied from the FT synthesizing unit 1060.

The upgrading unit 1080 mixes the FT wax supplied from the FT synthesizing unit 1060 and H₂ supplied from the extractor 1054 of the conditioning unit 1050 with each other to produce a syncrude mixture in which FT naphtha, FT heavy oil, and FT wax are mixed with each other.

That is, as illustrated in FIG. 7, H₂ recovered in the extractor 1054 passes through a second compressor 1081 and a fifth heat exchanger 1082 to thereby be supplied to a reactor 1083 producing a mixture by a hydrogenolysis or mild hydroisomerization reaction with respect to the FT wax.

As described above, since H₂ is recovered in the extractor 1054 to thereby be supplied to the reforming unit 1040 and the upgrading unit 1080, there is no need to install an additional hydrogen producing apparatus, the ratio(SN) of H₂/CO supplied to the FT reactor is maintained at 1 to 2.5, and the recovered hydrogen may be used to treat the FT product.

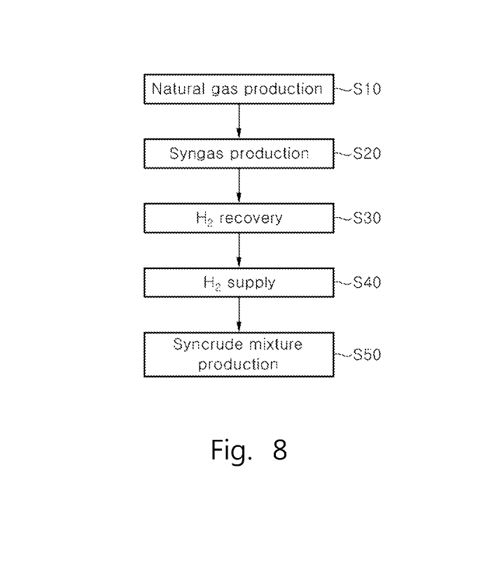

Next, a process of recovering hydrogen, which is performed by the FT GTL apparatus on the FPSO using the SMR as illustrated in FIGS. 6 and 7, will be described with reference to FIG. 8.

FIG. 8 is a process diagram for describing a GTL producing method using the SMR according to the second embodiment of the present invention.

A FT GTL method on the FPSO using the SMR according to the second embodiment of the present invention is a method of supplying an amount of hydrogen required in a FT GTL producing process on the FPSO using the SMR. In the FT GTL method, first, raw natural gas is stabilized in the gas injection stabilizing unit 1010, sulfur contained in the raw natural gas is removed in the desulfurizing unit 1020, and natural gas is produced through the natural gas saturating and pre-reforming unit 1030 (S10).

The mixed gas of H₂, CO, and H₂O is produced from the natural gas in the reforming unit 1040 (S20).

Then, H₂O is separated in the conditioning unit 1050 from the mixed gas produced in S20 in multiple steps, and H₂ is separated and recovered so as to satisfy requirement conditions of the FT synthesizing unit 1060 (S30).

H₂ recovered in S30 is supplied to the reforming unit 1040 and the upgrading unit 1080 (S40). Recovery of H2 in S30 is performed by the membrane provided in the extractor 1054 so that the ratio(SN) of H₂/CO supplied to the FT synthesizing unit satisfies 1 to 2.5. Further, H₂ supplied to the reforming unit 1040 is used as fuel.

In the upgrading unit 1080, the syncrude mixture is produced by mixing the FT wax supplied from the FT synthesizing unit 1060 and H₂ supplied from the conditioning unit 1050 (S50).

S50 is performed by a reactor 1083 performing a wax hydrogenolysis reaction or mild hydroisomerization reaction.

It will be apparent to those skilled in the art to which the present invention pertains that the present invention is not limited to the above-mentioned embodiments but may be variously modified and changed without departing from the technical idea of the present invention.

1. A gas-to-liquid (GTL) producing method for floating production, storage, and offloading (FPSO) comprising:
1) a pre-treating step of pre-treating natural gas produced at an offshore gas field;
2) a reforming step of reacting the pre-treated natural gas in a presence of a catalyst to produce syngas containing hydrogen and carbon monoxide;
3) a synthesis step of supplying the syngas to a Fischer-Tropsch reactor and reacting the syngas to produce liquid hydrocarbon; and
4) an upgrading step of separating the liquid hydrocarbon into gas, naphtha, and syncrude and supplying hydrogen to hydrofinish the liquid hydrocarbon.

2. The GTL producing method for FPSO of claim 1, wherein the upgrading step includes:
1) a separation step of separating the liquid hydrocarbon produced in the synthesis step into gas having 1 to 4 carbon atoms, naphtha, and syncrude; and
2) a hydrofinishing step of supplying hydrogen to the separated naphtha to saturate olefin.

3. The GTL producing method for FPSO of claim 2, wherein a condensate produced in the hydrofinishing step is separated to thereby be mixed with the syncrude separated in the separation step, and
gum formation and polymerization of olefin contained in at least one of the naphtha and syncrude during storage and transportation are prevented through the hydrofinishing step.

4. The GTL producing method for FPSO of claim 2, wherein the gas having 1 to 4 carbon atoms separated in the separation step is supplied as fuel for the FPSO.

5. The GTL producing method for FPSO of claim 2, wherein the hydrofinishing step is performed at a relatively low temperature of 250 to 290° C. and a relatively low pressure of 15 to 30 bars.

6. The GTL producing method for FPSO of claim 1, further comprising a conditioning step of conditioning the syngas produced after the reforming in the reforming step before supplying the syngas to the Fischer-Tropsch reactor of the synthesis step,
wherein hydrogen generated during the conditioning is at least partially supplied to the upgrading step.

7. The GTL producing method for FPSO of claim 6, wherein the reforming step is performed in a steam CO₂ reformer (SCR) supplying steam and carbon dioxide to the natural gas and reacting the natural gas in the presence of the catalyst, and
the Fischer-Tropsch reactor in the synthesis step is a slurry phase reactor (SPR).

8. The GTL producing method for FPSO of claim 7, wherein the steam CO₂ reformer is a compact reformer.

9. The GTL producing method for FPSO of claim 8, wherein carbon dioxide participates in a production reaction of the syngas as a reverse reaction of a water gas shift reaction in the compact reformer.

10. The GTL producing method for FPSO of claim 7, wherein the syngas unreacted in the slurry phase reactor is recovered to thereby be re-supplied to the synthesis step.

11. The GTL producing method for FPSO of claim 1, wherein steam generated in the synthesis step and the reforming step is supplied to a steam turbine power generator provided in the FPSO, thereby generating power.

12. The GTL producing method for FPSO of claim 6, wherein in the conditioning step, H₂O is separated in multiple steps from the syngas produced after the reforming, and hydrogen is separated so as to satisfy requirement conditions in the Fischer-Tropsch reactor, but
H₂ is recovered so that a ratio(SN) of H₂/CO supplied to the Fischer-Tropsch reactor satisfies 1 to 2.5.

13. The GTL producing method for FPSO of claim 12, wherein hydrogen recovered in the conditioning step is at least partially supplied as fuel in the reforming step.

14. The GTL producing method for FPSO of claim 13, wherein the reforming step is performed in a steam methane reformer (SMR) reacting the natural gas with hydrogen supplied in the conditioning step.

15. A GTL producing system for FPSO comprising:
a pre-treating unit in which pre-treatment including desulfurization is performed on natural gas produced at an offshore gas field;
a reformer receiving the natural gas from the pre-treating unit to produce syngas containing hydrogen and carbon monoxide;
a Fischer-Tropsch reactor receiving the syngas from the reformer to produce liquid hydrocarbon; and
an upgrading unit receiving hydrogen and the liquid hydrocarbon from the Fischer-Tropsch reactor and hydrofinishing the liquid hydrocarbon to produce naphtha and syncrude.

16. The GTL producing system for FPSO of claim 15, further comprising a conditioning unit conditioning the syngas produced in the reformer before the syngas is supplied to the Fischer-Tropsch reactor,
wherein hydrogen produced in the conditioning unit is supplied to the upgrading unit.

17. The GTL producing system for FPSO of claim 15, wherein the reformer is a steam CO₂ reformer (SCR) receiving the natural gas to supply steam and carbon dioxide, and reacting the natural gas in a presence of a catalyst to produce the syngas containing hydrogen and carbon monoxide, and
the Fischer-Tropsch reactor is a slurry phase reactor (SPR).

18. The GTL producing system for FPSO of claim 15, wherein the upgrading unit supplies hydrogen to the liquid hydrocarbon and hydrofinishes the liquid hydrocarbon to saturate olefin contained in at least one of the naphtha and syncrude, thereby preventing gum formation and polymerization of the olefin during storing and transporting at least one of the naphtha and syncrude.

19. The GTL producing system for FPSO of claim 15, wherein compounds having 1 to 4 carbon atoms, produced in the Fischer-Tropsch reactor and the upgrading unit are supplied as fuel of a complex power generation system of the FPSO.

20. The GTL producing system for FPSO of claim 16, wherein the conditioning unit includes:
first to third separators separating H₂O from the syngas in multiple steps; and
an extractor recovering hydrogen from hydrogen and carbon monoxide separated in the third separator.

21. The GTL producing system for FPSO of claim 20, wherein the reformer is a steam methane reformer (SMR) reforming the pre-treated natural gas and H₂O and CO₂ into combustion gas and hydrogen, and CO and H₂O using hydrogen recovered in the extractor.

22. The GTL producing system for FPSO of claim 20, wherein the extractor is provided with a membrane capable of adjusting an amount of passed hydrogen.

23. The GTL producing system for FPSO of claim 22, wherein hydrogen recovered by the membrane is supplied to the reformer and the upgrading unit.

24. The GTL producing system for FPSO of claim 22, wherein a ratio(SN) of H₂/CO supplied from the conditioning unit to the Fischer-Tropsch reactor is 1 to 2.5.
